(19) United States
(12) Patent Application Publication
(10) Pub. No.: US 2012/0108686 A1
(43) Pub. Date: May 3, 2012

(54) Method For Determining The Performance Of A Superabsorbent Polymer Material

(75) Inventors: Pierre VERSTRAETE, Strombeek-Bever (BE); Torsten LINDNER, Kronberg (DE); Axel MEYER, Frankfurt am Main (DE); Mattias SCHMIDT, Idstein (DE); Kai GRASS, Frankfurt am Main (DE); Christian HOLM, Stuttgart (DE)

(73) Assignee: The Procter & Gamble Company, Cincinnati, OH (US)

(21) Appl. No.: 13/283,719

(22) Filed: Oct. 28, 2011

(30) Foreign Application Priority Data
Oct. 29, 2010 (EP) 10189399.8

(51) Int. Cl. C08J 3/24; G06G 7/58; G06F 17/10; C08F 20/18; G06G 7/48

(52) U.S. Cl. 521/31; 703/6; 703/2; 703/11

(57) ABSTRACT

Method for determining the performance of a superabsorbent polymer material by using a virtual model of the superabsorbent polymer material comprising the steps of inputting values of one or more first molecular parameter(s) into the virtual model and calculating the value(s) of one or more first performance output parameter(s) and inputting values of one or more second molecular parameter(s) into the virtual model and calculating the value(s) of one or more second performance output parameter(s) and determining the variation between the value(s) of the one or more first performance output parameter(s) and the value(s) of the one or more second performance output parameter(s).

### FIELD OF THE INVENTION

The present invention is directed to a method for determining the performance of a superabsorbent polymer material by using a virtual model of the superabsorbent polymer material.

### BACKGROUND OF THE INVENTION

Absorbent articles, such as disposable diapers, training pants, and adult incontinence undergarments, absorb and contain body exudates. Some absorbent articles, like diapers, contain absorbent polymer materials also known as superabsorbent polymer materials.

Superabsorbent polymer materials are able to absorb liquid and swell when entering into contact with liquid exudates. However, it has been shown in the past that not all categories of superabsorbent polymer materials are suitable for use in an absorbent article.

Indeed, superabsorbent polymer materials not only need to absorb large amount of liquids, but they also need to maintain their shape during the swelling process. During the swelling process, superabsorbent polymer materials typically form a gel. However, it may happen that the gel forms a seal in the top layer of the absorbent article, and thus prevent further liquid from reaching the un-utilized superabsorbent polymer materials in the lower layers. This phenomenon, called “gel blocking”, may induce leakage in the absorbent article. Therefore, it is important to have superabsorbent polymer materials which are strong enough and to avoid that the gel becomes “too soft”, i.e. that the gel conforms too much after liquid uptake.

Hence, superabsorbent polymer materials particularly suitable for use in absorbent articles should consequently exhibit high absorption capacity while simultaneously maintain high gel strength.

A so-called capacity/gel strength trade off curve representing the variation of the gel strength with the absorption capacity is typically generated in order to select the most suitable superabsorbent polymer material with the better trade-off between capacity and gel strength. Any improvement of this trade-off curve enables better performance or cost savings of absorbent articles comprising such superabsorbent polymer materials.

The absorption capacity and the gel strength of the superabsorbent polymer materials may depend on different molecular parameter(s) of the materials. For example, the absorption capacity and gel strength of the materials may depend on the fraction of cross-linker present during the polymerization process. Indeed, the higher the fraction of cross-linker the lower the capacity and the higher the gel strength.

Up to now, testing the influence of different molecular parameters of the superabsorbent polymer materials on the performance parameter(s) of the superabsorbent polymer materials such as the absorption capacity and gel strength has required the manufacturing of different samples of superabsorbent polymer materials, each of them having different values for the molecular parameter of interest. The manufacturing of such superabsorbent polymer materials can be quite challenging since it is important to make sure that during the synthesis, only the tested parameter is varying. Otherwise, interpreting the results on capacity and gel strength can be more difficult. In addition, the manufacturing of superabsorbent polymer materials can considerably increase the development costs.

Thus, there is a need for a reliable and cost effective method which enables the testing of the influence that different molecular parameters of superabsorbent polymer materials may have on the performance parameter(s) of such materials.

Thereto, the inventors have found that molecular dynamics simulations can be used for this purpose.

The inventors have developed a method using a coarse-grained molecular dynamics model in order to test the influence of different molecular parameters of superabsorbent polymers on the performance of such polymers in a reliable, time- and cost-effective manner since no synthesis of these materials is consequently needed for testing. Once the appropriate value(s) of the molecular parameter(s) have been determined by the method, only the superabsorbent polymer materials having such value(s) for the molecular parameter(s) can be synthesized.

### SUMMARY OF THE INVENTION

In a first embodiment, a method for determining the performance of a superabsorbent polymer comprises the steps of:
a) inputting the value(s) of one or more first molecular parameter(s) of the superabsorbent polymer into a coarse-grained molecular dynamics model; and calculating the value(s) of one or more first performance output parameter(s); and
b) inputting the value(s) of one or more second molecular parameter(s) of the superabsorbent polymer into said coarse-grained molecular dynamics model; and calculating the value(s) of one or more second performance output parameter(s); and
c) determining the variation between the value(s) of the one or more first performance output parameter(s) and the value(s) of the one or more second performance output parameter(s).

The variation determined in step c) is determined between different values of the same first and second performance output parameter.

In some embodiments, the method is used for obtaining superabsorbent polymer materials suitable for use in absorbent articles.

In some embodiments, a computer system having a central processing unit, a graphical user interface including a display communicatively coupled to the central processing unit, and a user interface selection device communicatively coupled to the central processing unit, uses the method of the present invention.

### BRIEF DESCRIPTION OF THE DRAWINGS

FIG. 1 is a representation of a portion of a polyacrylate polymer under the coarse-grained molecular dynamics approach.

FIG. 2 is a representation of a cubic simulation cell comprising a superabsorbent polymer as displayed by the LAMMPS software.

### DETAILED DESCRIPTION OF THE INVENTION

“Superabsorbent polymer material” is used herein to refer to a superabsorbent polymer material which may be obtained by any polymerization process known by the person skilled in the art.

“Superabsorbent polymer” is used herein to refer to a superabsorbent polymer material which is simulated according to the coarse-graining approach.

A superabsorbent polymer and a superabsorbent polymer material can typically absorb at least 10 times its weight of an aqueous 0.9% saline solution as measured using the Centrifuge Retention Capacity test (EDANA WSP 241.2 (05)).

A superabsorbent polymer material may be in particulate form so as to be flowable in the dry state. This may be any polymeric material with such a Centrifuge Retention Capacity, such as starch-based superabsorbent polymer materials, or in some embodiment this material may be or include poly(meth)acrylic acid/poly(meth)acrylate polymer materials, or preferably polyacrylic acid/polyacrylate polymer materials.

“Absorbent articles” is used herein to refer to devices that absorb and contain body exudates, and, more specifically, refers to devices that are placed against or in proximity to the body of the wearer to absorb and contain the various exudates discharged from the body. Absorbent articles include diapers, training pants, adult incontinence undergarments, feminine hygiene products and the like.

### The Coarse-Grained Molecular Dynamics Model

The present method uses a coarse-grained molecular dynamics model to simulate a superabsorbent polymer material.

The superabsorbent polymer of the model comprises polyelectrolyte polymer chains of polymerized monomers connected to uncharged cross-linker molecules. In such a model, the atomistic details of the polyelectrolyte polymer chains and of the cross-linker molecules are coarse-grained out and represented by spherical beads.

The chains are charged depending on the degree of neutralization of the superabsorbent polymer network. The charged monomers of the polyelectrolyte polymer chains are represented by charged spherical beads with the electric charges of the beads being placed at the center of the beads. The spherical beads representing the monomers of a polyelectrolyte polymer chain are connected by non-linear elastic springs.

In some embodiments, the superabsorbent polymer further comprises counterions. In such embodiments, the counterions are also represented by charged spherical beads with the electric charges of the beads being also placed at the center of the beads.

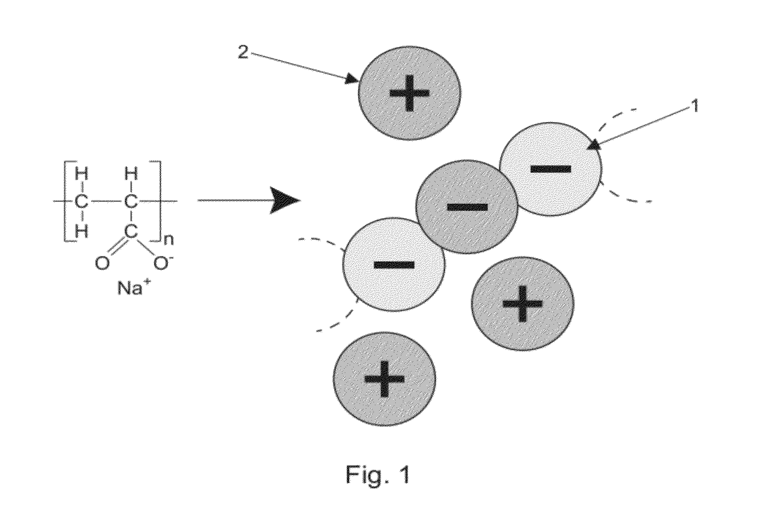

In some embodiments, the superabsorbent polymer is a cross-linked sodium polyacrylate polymer. In such embodiments, as for example shown on FIG. 1, the monomers are polymerized acrylate monomers 1 which are represented by negatively-charged spherical beads with the negative charge being placed at the center of the beads and the counterions are sodium ions 2 which are represented by positively-charged spherical beads with the positive charge being placed at the center of the beads.

In the embodiments wherein the performance of the superabsorbent polymer is determined for a swollen gel of the superabsorbent polymer which is contained in a saline solution, the sodium and the chloride ions, are also represented by charged spherical beads with the electric charges of the beads being also placed at the center of the beads.

In some embodiments, the superabsorbent polymer is represented by a diamond lattice comprising 16 polyelectrolyte polymer chains which are connected to 8 tetra-functional cross-linker molecules. In some of these embodiments, the superabsorbent polymer is further neutralized by adding the required amount of counterions such as the sodium ions.

In some other embodiments, the superabsorbent polymer is represented by a regular cubic lattice comprising 24 polyelectrolyte polymer chains which are connected to 8 hexa-functional cross-linker molecules. In some of these embodiments, the superabsorbent polymer is further neutralized by adding the required amount of counterions such as the sodium ions.

In some other embodiments, the superabsorbent polymer is represented by a regular cubic centered lattice comprising 64 polyelectrolyte polymer chains which are connected to 16 octafunctional cross-linker molecules. In some of these embodiments, the superabsorbent polymer is further neutralized by adding the required amount of counterions such as the sodium ions. The coarse-grained molecular dynamics simulation uses reduced simulation units (r.s.u.) for all physical observables, i.e. they are dimensionless when expressed in terms of some scale parameters. The scales for length and energy quantities are respectively a and c, which depend on the chosen model parameters.

The equilibrium bond-length between the polymerized monomers of the polyelectrolyte polymer chains of the model is determined by the parameters describing the below mentioned potentials (i.e. the truncated Lennard-Jones, the FENE and the coulomb potential). The equilibrium bond-length is b₀=0.9 r.s.u.

Interactions:

According to the model of the present invention, the polymerized monomers of the polyelectrolyte polymer chains interact with one another intra and inter molecular, with the cross-linker molecules and with the counterions (when present) via a truncated (and shifted) Lennard-Jones (or Weeks-Chandler-Anderson) potential as defined in the following formula (F1):

$${U}_{L J} ( {r}_{ij} < {r}_{cut} ) = 4 ε [ {( \frac{σ}{{r}_{ij}} )}^{12} - {( \frac{σ}{{r}_{ij}} )}^{6} + \frac{1}{4} ]$$

wherein σ is the length parameter, ε the energy parameter, rᵢⱼ the distance between the centres of two beads i and j and r_{cut} the cut-off distance beyond which the interaction potential is zero.

In the embodiments wherein the performance of the superabsorbent polymer is determined for a swollen gel of the superabsorbent polymer which is contained in a saline solution, the polymerized monomers of the polyelectrolyte polymer chains also interact with the ions of the saline solution via the above-mentioned truncated (and shifted) Lennard-Jones (or Weeks-Chandler-Anderson) potential.

In some embodiments, the parameters are chosen to be: ε=1.0 r.s.u, σ=1.0 r.s.u. and r_{cut}=2^{1/6}=1.12246 r.s.u.

The polymerized monomers of a same polyelectrolyte polymer chain interact with one another and with the cross-linker molecules to which the chain is connected via a FENE (Finitely Extendible Nonlinear Elastic) potential as defined in the following formula (F2):

$$U ( {r}_{ij} ) = - \frac{1}{2} {KR}_{max}^{2} ln [ 1 - {( \frac{{r}_{ij} - {r}_{0}}{{R}_{max}} )}^{2} ]$$

wherein rᵢⱼ the distance between the centre of two beads i and j, K is the force constant, r₀ the bond length at equilibrium and Rₘₐₓ the bond length maximum.

In some embodiments, the parameters are chosen to be: K=10.0 r.s.u., Rₘₐₓ=1.5 r.s.u. and r₀=0.0.

The polymerized monomers of the polyelectrolyte polymer chains of the model interact with one another intra and inter molecular and with the counterions (when present) via a coulomb potential as defined in the following formula (F3):

$${U}_{C} ( {r}_{ij} ) = {l}_{B} {k}_{B} T \frac{{q}^{2}}{{r}_{ij}}$$

wherein q is the charge which is carried by all charged elements of the system (chain monomers/counterions (when present)), k_{B}T is the temperature of the system, l_{B} is the Bjerrum length, rᵢⱼ the distance between the centre of two beads i and j.

The Bjerrum length defines the length scale at which the strength of the electrostatic interactions between two charges in a system is exactly equal to the thermal energy in the system: l_{B}=e²/(4πε₀εᵣk_{B}T), where e is the elementary charge, ε₀ is the dielectric permittivity of the vacuum and εᵣ the relative permittivity.

The counterions also interact with one another via a coulomb potential as defined in the above mentioned formula F3.

In the embodiments wherein the superabsorbent polymer is contained in a saline solution, the chloride and sodium ions of the saline solution also interact with one another, with the polymerized monomers of the polyelectrolyte polymer chains and with the counterions via a coulomb potential as defined in the above mentioned formula F3.

In some embodiments, the parameters are chosen to be: q=±1 r.s.u., k_{B}T=1.0 r.s.u. and l_{B}=2.58 r.s.u.

The coulomb interaction is calculated using the P3M (Particle-Particle-Particle-Mesh) algorithm under 3D periodic boundary conditions with metallic surface term and an accuracy of 10⁻².

Conversion Between Reduced and Real-World Units:

As mentioned above, the length-scale σ and the energy-scale ε of the model are expressed in reduced simulation units (r.s.u.). However, these two parameters as well as additional parameters such as the volume and the pressure of the model can also be converted into real-world units.

In the model, the equilibrium bond-length between the polymerized monomers of the polyelectrolyte polymer chains is b₀=0.9 r.s.u. In the real-world, the distance between two polymerized acrylate monomers of a polyacrylate polymer material is approximately 2.5 Angstrom. The ratio between these two values gives the length-scale expressed in real-world units.

$$σ = \frac{25 Å}{0.9} = 2.78 Å$$

In the model, the system is simulated at constant room temperature (˜300K) using a Langevin thermostat with friction Γ=1.0 and temperature T=1.0. The energy-scales are expressed in real-world units as follow:

ε=k_{B}T=1.38×10⁻²³ J/K·300 K=4.14×10⁻²¹ J

Volume: The conversion between reduced simulation units and real-world units for the volume is:

1r.s.u.≡σ³=21.4×10⁻³⁰ m³

Pressure: The conversion between reduced simulation units and real-world units for the pressure (and analogously for the bulk modulus) is:

$$1 r . s . u ≡ \frac{ε}{{σ}^{3}} = 1.93 \times {10}^{8} Pa$$

### Description of the Method

The method according to the present invention enables the determination of the performance of a superabsorbent polymer.

In this method, the value(s) of one or more first molecular parameter(s) of a superabsorbent polymer are inputted into a coarse-grained molecular dynamics model and the value(s) of one or more first performance output parameter(s) are then calculated. The value(s) of one or more second molecular parameter(s) of a superabsorbent polymer are inputted into the coarse-grained molecular dynamics model and the value(s) of one or more second performance output parameter(s) are then calculated. The variation between the value(s) of the one or more first performance output parameter(s) and the value(s) of the one or more second performance output parameter(s) is then determined.

As soon as a superabsorbent polymer or a superabsorbent polymer material enters into contact with a liquid it starts to swell. During the swelling process, the superabsorbent polymer or the superabsorbent polymer material typically forms a gel. The superabsorbent polymer or the superabsorbent polymer material swells until the swelling equilibrium is reached. At the swelling equilibrium, the amount of liquid absorbs by the superabsorbent polymer or the superabsorbent polymer material corresponds to the swelling capacity of the superabsorbent polymer or of the superabsorbent polymer material.

“Swelling gel” is used herein to refer to the gel of the superabsorbent polymer until the swelling equilibrium is reached.

“Swollen gel” is used herein to refer to the gel of the superabsorbent polymer at the swelling equilibrium.

In some embodiments, the performance of the superabsorbent polymer is determined for a swollen gel of the superabsorbent polymer which is contained in deionized water.

In some other embodiments, the performance of the superabsorbent polymer is determined for a swollen gel of the superabsorbent polymer which is contained in a saline solution. In some embodiments, the saline solution is a 0.01 to 5 w % saline solution (sodium chloride solution). In some other embodiments, the saline solution is a 0.9 w % saline solution.

In some embodiments, the value(s) of one or more first molecular parameter(s) inputted into the coarse-grained molecular dynamics model, form a first input value set of a first molecular parameter set, and the value(s) of one or more second molecular parameter(s) inputted into the coarse-grained molecular dynamics model, form a second input value set of a second molecular parameter set. In such embodiments, the first and second molecular parameter sets are the same. In some of these embodiments, the first and the second molecular parameter sets comprise molecular parameters which are selected from the group consisting of: cross-linker density, polydispersity index, percentage of dangling chains, degree of neutralization, functionality of the cross-linker molecules, percentage of extractable, molecular weight of the monomers and combinations thereof.

It should be understood for the purpose of the invention that in order to be able to determine the influence that one of the molecular parameters may have on the performance output parameters, only the value of one same molecular parameter has to differ between the first input value set and the second input value set.

In some embodiments, the first input value set and the second input value set comprise the values of the cross-linker density.

In some embodiments, additional input value sets may be inputted into the coarse-grained molecular dynamics model for which the value(s) of one or more performance output parameter(s) is/are calculated.

### The Molecular Parameter(s) (Input Parameters)

The Cross-Linker Density

The cross-linker density is defined as the ratio of the number of cross-linker molecules over the number of polymerized monomers of a superabsorbent polymer or of a superabsorbent polymer material.

In the embodiments wherein both the first and the second molecular parameter sets comprise the cross-linker density, the values of the cross-linker density may range between 0.01 to 2 mol %.

The Polydispersity Index

The term “polydispersity” is used herein to refer to the polydispersity of polyelectrolyte polymer chains which are disposed between two cross-linker molecules in a superabsorbent polymer or a superabsorbent polymer material.

The polydispersity index (PDI) is a measure of the distribution of molecular weights in a superabsorbent polymer or in a superabsorbent polymer material. The PDI is calculated by dividing the weight average molecular weight (M_{w}) of the superabsorbent polymer or of the superabsorbent polymer material by the number average molecular weight (Mₙ) of respectively the superabsorbent polymer or the superabsorbent polymer material. The PDI is denoted as:

$$P D I = \frac{{M}_{w}}{{M}_{n}} wherein {M}_{n} = \frac{\sum {M}_{i} {N}_{i}}{\sum {N}_{i}} and {M}_{w} = \frac{\sum {M}_{i}^{2} {N}_{i}}{\sum {M}_{i} {N}_{i}}$$

wherein Mᵢ is the molecular weight of a polyelectrolyte polymer chains of the superabsorbent polymer or of the superabsorbent polymer material comprising i monomers and Nᵢ is the number of polyelectrolyte polymer chains comprising i monomers.

In the embodiments wherein both the first and the second molecular parameter sets comprise the polydispersity index, the values of the polydispersity index may range between 1 and 5.

The Percentage of Dangling Chains

Dangling chains are imperfections of the superabsorbent polymer or of the superabsorbent polymer material network. In some embodiments, dangling chains are created by cutting the polymer chains of the superabsorbent polymer material at the cross-linker molecules. In some other embodiments, dangling ends are created by cutting the chains in the middle, thereby creating two dangling ends per cut.

In the embodiments wherein both the first and the second molecular parameter sets comprise the percentage of dangling chains, the percentage of dangling chains may range between 0% and 50%, preferably between 0% and 25%.

Degree of Neutralization

In some embodiments, the superabsorbent polymer or the superabsorbent polymer material network is neutralized. In some of these embodiments, the superabsorbent polymer or the superabsorbent polymer material network is neutralized with a sodium hydroxide solution. The degree of neutralization of a superabsorbent polymer or a superabsorbent polymer material corresponds to the percentage of polymerized monomers of respectively the superabsorbent polymer or the superabsorbent polymer material being negatively charged. For example, if the degree of neutralization is of 75 mol %, 75 mol % of the monomers are negatively charged and 25 mol % of the monomers are neutral.

In the embodiments wherein both the first and the second molecular parameter sets comprise the degree of neutralization, the values of the degree of neutralization may range between 0 and 100 mol %. In some preferred embodiments, the values of the degree of neutralization may range between 50 and 100 mol %.

Functionality of the Cross-Linker Molecules

In the embodiments wherein both the first and the second molecular parameter sets comprise the functionality of the cross-linker molecules, the cross-linker molecules may be tetrafunctional, hexafunctional or octafunctional.

In some embodiments, the superabsorbent polymer material may comprise tetrafunctional cross-linker molecules such as polyethyleneglycol di(meth)acrylate or methylenebisacrylamide, hexafunctional cross-linker molecules such as triallylamine and/or octafunctional cross-linker molecules such as tetraallyloxyethane.

The Percentage of Extractable

The percentage of extractable of a superabsorbent polymer or of a superabsorbent polymer material is defined as the weight percentage of respectively the superabsorbent polymer or the superabsorbent polymer material which is soluble in the liquid in which the superabsorbent polymer or the superabsorbent polymer material is contained. In other words, the percentage of extractable corresponds to the weight percentage of superabsorbent polymer or superabsorbent polymer material which is not retained in respectively the superabsorbent polymer or the superabsorbent polymer material network.

In the embodiments wherein both the first and the second molecular parameter sets comprise the percentage of extractable, the percentage of extractable may range between 0 and 50%, preferably between 0 and 15%:

Molecular Weight of the Monomers

In the embodiments wherein both the first and the second molecular parameter sets comprise the molecular weight of the monomers, the values of the molecular weight may range between 28 to 72 g/mol.

In some embodiments, the values of one or more first performance output parameters are calculated forming a first output value set of a first output parameter set. In these embodiments, the values of one or more second performance output parameters are also calculated forming a second output value set of a second output parameter set. In some of these embodiments, the first and the second output parameter sets are selected from one of the following parameters: Swelling Capacity, bulk modulus, shear modulus and combinations thereof.

### The Performance Output Parameters:

Swelling Capacity

The swelling capacity of a superabsorbent polymer or a superabsorbent polymer material refers to the maximum amount of swelling solution in which respectively the superabsorbent polymer or the superabsorbent polymer material is contained that can be absorbed by respectively the superabsorbent polymer or the superabsorbent polymer material. The swelling capacity is measured at the swelling equilibrium. The swelling capacity is typically expressed in g/g (grams of swelling solution/grams of dry superabsorbent polymer or dry superabsorbent polymer material).

The swelling capacity is proportional to the swelling volume of the superabsorbent polymer gel at the swelling equilibrium.

The swelling volume of the superabsorbent polymer gel at the swelling equilibrium can be obtained via the P-V (Pressure-Swelling Volume) diagram of the tested superabsorbent polymer system (at constant temperature T) as explained hereinafter in detail.

The gel strength of a superabsorbent polymer may be characterized through the calculation of different output parameters such as the bulk modulus or the shear modulus of the superabsorbent polymer gel. The gel strength is typically determined at the swelling equilibrium volume, i.e. where the internal pressure equals the external pressure, as explained hereinafter in details.

Bulk Modulus

The bulk modulus (K) of a superabsorbent polymer or a superabsorbent polymer material gel measures the resistance of respectively the superabsorbent polymer or the superabsorbent polymer material gel to uniform compression.

The bulk modulus of a superabsorbent polymer gel can be obtained via the derivative of the p-V-diagram of the tested system (at constant temperature T):

K(T)=−V(∂p/∂V).

Method for calculating the swelling capacity and/or the bulk modulus of a superabsorbent polymer gel at the swelling equilibrium

The swelling gel of a superabsorbent polymer has a swelling volume V and an internal pressure Pᵢₙₜ. The liquid in which the swelling gel of a superabsorbent polymer is contained, i.e. the swelling liquid exerts an external pressure Pₑₓₜ onto the gel.

In this method, the swelling volume V of a superabsorbent polymer gel is varied by inputting increasing values Vᵢ for the swelling volume V. For each inputted swelling volume values Vᵢ, the corresponding internal pressure values P_{int, i} is calculated. A P_{int, i}=f(Vᵢ) diagram is then generated. The swelling capacity and the bulk modulus of the superabsorbent polymer are then calculated from the P_{int, i}=f(Vᵢ) diagram, the swelling capacity being proportional to the value of the swelling volume V_{i (eq)} for which the internal pressure Pᵢₙₜ is equal to the external pressure Pₑₓₜ and the bulk modulus being equal to the slope of the P_{int, i}=f(Vᵢ) diagram determined at the swelling volume value V_{i(eq)}.

The swelling capacity (C₀) is calculated according to the following formula:

C₀(Swelling capacity)=(V_{i(eq)}*ρ_{water})/M

wherein ρ_{water} is the water density and M is the mass of the dry superabsorbent polymer.

In some embodiments, wherein the superabsorbent polymer is a polyacrylate polymer which comprises 16 polyelectrolyte polymer chains of polymerized acrylate monomers connected to 8 tetra-functional cross-linker molecules, M is calculated according to the following formula:

$$M = \frac{16 {NM}_{PA} + 8 {M}_{CL}}{{N}_{A}} \frac{1}{( 1 - ρ w )}$$

wherein N is the length of the polymer chain (N=25-300), M_{PA} is the average molecular mass of the acrylate monomers taking into account the degree of neutralization (M_{PA}=94/83/79.3 g/mol for 100%/50%/33% neutralization), M_{CL} is the molecular mass of the cross-linker molecules (M_{CL}=500 g/mol), and ρ_{W} is the percentage of residual water which is typically equal to 0.5% and N_{A} is the Avogadro Number.

In some embodiments, the first input value set and the second input value set inputted into the coarse-grained molecular dynamics model comprise the values of the cross-linker density. In such embodiments, the values of the swelling capacity and the bulk modulus can be calculated in response to each value of the cross-linker density which is inputted into the model. A K=f(C₀) diagram can then be generated. This diagram represented the so-called capacity/gel strength trade off curve representing the variation of the gel strength (represented by the bulk modulus) with the absorption capacity. This diagram will help to understand the influence that the molecular parameter(s) of a superabsorbent polymer may have on its swelling capacity and bulk modulus. The person skilled in the art will be able to determine from the diagram the suitable molecular parameter values that a superabsorbent polymer material needs to have in order to exhibit the best performances.

Shear Modulus

The shear modulus of a superabsorbent polymer or a superabsorbent polymer material gel measures the resistance of respectively the superabsorbent polymer or the superabsorbent polymer material gel to shearing strains.

### Method for Calculating the Shear Modulus

In some embodiments, the shear modulus of a superabsorbent polymer gel is determined at the swelling equilibrium by inputting different values x, for the shear strain of the superabsorbent polymer and calculating the corresponding shear stress yᵢ for each value xᵢ. The volume of the superabsorbent polymer gel of the model is maintained constant. A yᵢ=f(xᵢ) diagram is then generated. The shear modulus is calculated from the generated diagram, the shear modulus being equal to the slope of the yᵢ=f(xᵢ) diagram.

Alternatively, the shear modulus G of the superabsorbent polymer gel can be calculated via the following formula, wherein v represents the Poisson's ratio of the material:

$$G = \frac{3 ( 1 - 2 v )}{2 ( 1 + v )} K$$

wherein K is the bulk modulus of the superabsorbent polymer gel.

In some embodiments, the poisson's ratio of the superabsorbent polymer gel may be of 0.45. In such embodiments, the shear modulus G will be G≈0.1 K.

In the method of the present invention, only the variation between different values of the same first and second performance output parameters is determined. For example, if one of the first performance output parameter is the swelling capacity, one of the second performance output parameter has to also be the swelling capacity.

### Software

The coarse-grained molecular dynamics model is formulated and all the calculations are performed by using the software package ESPRESSO or LAMMPS.

The software package ESPRESSO used is the ESPRESSO version 2.1.2 g, MPI for Polymer Research, Mainz, Germany, available from http://espressowiki.mpip-mainz.mpg.de.

The software package LAMMPS used is the LAMMPS version Jun. 27, 2010, available from http://lammps.sandia.gov/.

In some embodiments, a computer system can be used for operating the coarse-grained molecular dynamics model. The computer system comprises a central processing unit, a graphical user interface including a display communicatively coupled to the central processing unit, and a user interface selection device communicatively coupled to the central processing unit. The user interface selection device can be used to input data and information into the central processing unit. The central processing unit can include or has access to memory or data storage units, e.g., hard drive(s), compact disk(s), tape drive(s), and similar memory or data storage units for storing various data and inputs which can be accessed and used in operating the coarse-grained molecular dynamics model.

Central processing unit can be part of a SUN workstation running a UNIX® operating system, part of a personal computer using INTEL® PC architecture and running a MICROSOFT WINDOWS® operating system, or part of another similarly capable computer architecture and accompanying operating system.

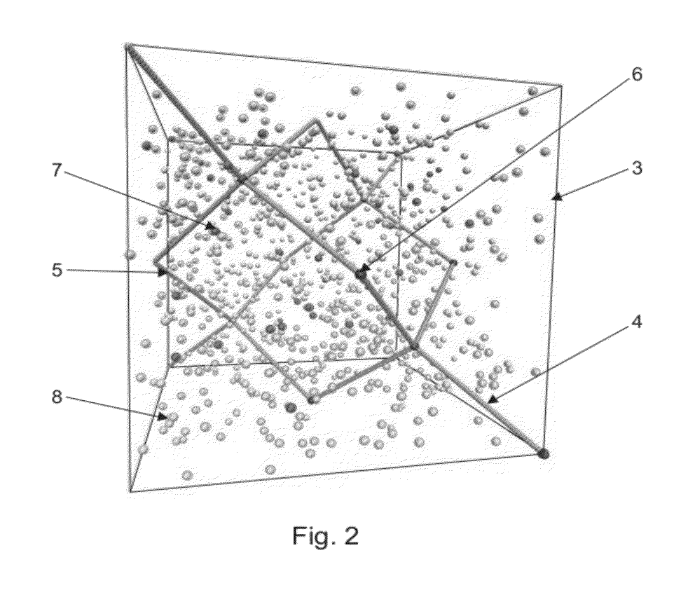

A superabsorbent polymer is displayed by the software in a cubic simulation cell 3 as for example shown in FIG. 2. In some embodiments, as for example shown in FIG. 2, the cubic simulation cell 3 comprises a superabsorbent polymer material 4 which is contained in a saline solution. In some of these embodiments, as for example shown on FIG. 2, the superabsorbent polymer comprised in the cubic simulation cell 3 comprises 16 polyelectrolyte polymer chains 5 of polymerized monomers connected to 8 tetra-functional cross-linker molecules 6. The cubic simulation cell 3 further comprises the sodium counterions 7 and the chloride co-ions 8 of the saline solution.

In some embodiments, the method according to the present invention may further comprise additional validation steps in order to verify if the variation between the value(s) of the one or more first performance output parameter(s) and the value(s) of the one or more second performance parameter(s) which is determined by the method is in accordance with what is observed in reality.

In such embodiments, a first and a second superabsorbent polymer material may be obtained by any polymerization process known by the person skilled in the art. The value(s) of the same one or more first molecular parameter(s) as the one or more first molecular parameter(s) inputted into the coarse-grained molecular dynamics model are measured by analytical methods for the first superabsorbent polymer material and the value(s) of the same one or more second molecular parameter(s) as the one or more second molecular parameter(s) inputted into the coarse-grained molecular dynamics model are also measured by analytical methods for the second superabsorbent polymer material.

The value(s) of the one or more first performance output parameter(s) of the first superabsorbent polymer material and the value(s) of the one or more second performance output parameter(s) of the second superabsorbent polymer material are measured by analytical methods.

The variation between the value(s) of the one or more first performance output parameter(s) and the value(s) of the one or more second performance output parameter(s) measured by analytical methods is then determined and compare with the variation between the value(s) of the one or more first performance output parameter(s) and the value(s) of the one or more second performance output parameter(s) determined by the simulation.

The variation between the value(s) of the one or more first performance output parameter(s) and the value(s) of the one or more second performance output parameter(s) measured by analytical methods is determined between different values of the same first and second performance output parameter.

In some embodiments, wherein one of the first and one of the second molecular parameter(s) are the cross-linker density and/or the percentage of dangling chains and/or the functionality of the cross-linker molecules, the value(s) of respectively the cross-linker density and/or the percentage of dangling chains and/or the functionality of the cross-linker molecules can be measured by using NMR including 1H-NMR or 13C-NMR including MAS (Magic Angle Spinning) technique as know by the person skilled in the art.

In some embodiments, wherein one of the first and one of the second molecular parameter(s) are the degree of neutralization, the value(s) of the degree of neutralization can be measured by acid/base titration as known by the person skilled in the art. In some embodiments, wherein one of the first and one of the second molecular parameter(s) are the percentage of extractable, the percentage of extractable can be measured according to EDANA method WSP 270.2 (05).

In some embodiments wherein one of the first and one of the second performance output parameter(s) are the swelling capacity C₀, the value(s) of the swelling capacity C₀ can be measured according to Cylinder Centrifuge Retention Capacity (CCRC) method described on pages 70 and 71 of WO 2006/083585 A2.

In some embodiments wherein one of the first and one of the second performance output parameter(s) are the shear modulus, the value(s) of the shear modulus G of a swollen gel of a superabsorbent polymer material, especially of a polyacrylate superabsorbent polymer material can be calculated according to the following equation which corresponds to a modified version of the equation 5.34 disclosed on page 203 of “Modern Superabsorbent Polymer Technology”, Frederic L. Buchholz, Andrew T. Graham, Wiley-VCH, Edition 1998:

$$G = \frac{P}{{( \frac{{C}_{0}}{1.02 * {Q}_{eq}} )}^{\frac{1}{0.44}} - 1}$$

with Q_{eq}=1.1*Q_{(96 h)}, wherein C₀ is the value of the swelling capacity, Q_{eq} is the value of the Absorption, Against Pressure (AAP) of the superabsorbent polymer material measured at the swelling equilibrium, Q_{(96 h)} is the value of the Absorption Against Pressure after 96 h (96 h-AAP) of the superabsorbent polymer material as measured according to the 96 h-AAP test method herein disclosed and P is the value of the pressure which is applied to the sample of the superabsorbent polymer material which is tested according to the 96 h-AAP test method. According to the 96 h-AAP test method herein disclosed, the value of the applied pressure is P=0.7 psi (4.83 kPa).

In some embodiments, additional superabsorbent polymer materials having different molecular parameter values may be used for the validation steps.

The method according to the present invention is particularly advantageous since it is possible to predict the influence that the molecular parameter(s) of superabsorbent polymer materials may have on the performance parameter(s) of such superabsorbent polymer material(s) in a time- and cost-effective manner since no synthesis of superabsorbent polymer materials having different values for the molecular parameters needs to be made.

Furthermore, the influence that the molecular parameter(s) of superabsorbent polymer materials may have on the performance parameter(s) of such superabsorbent polymer material(s) can be determined in a more accurate manner since a high number of different values for each molecular parameter can be inputted into the model. It would not be possible to synthesize the corresponding amount of superabsorbent polymer materials with different values of molecular parameter(s) since this would considerably increase the development costs.

Once the targeted output parameter value(s) has/have been determined, the superabsorbent polymer material with the corresponding molecular parameter value(s) can then be synthesized. Therefore, the method according to the present invention can be used for obtaining superabsorbent polymer material suitable for use in absorbent articles in a time- and cost-effective manner.

### Test Method

96 h-AAP Test Method

This method determines the capacity of superabsorbent polymer materials to absorb saline solution under a specified pressure applied for 96 h.

The procedure of the EDANA Absorption Under Pressure Test Method 442.2-02 has been followed with the following modifications:

Section 4 has been replaced by the following:

### 4. Principle

The test portion is weighed and spread on the bottom filter screen closing a specified cylinder. A uniform pressure is applied on the test portion. The cylinder is then placed on a filter plate, which is placed in a Petri dish filled with saline solution. After an absorption contact time of 96 hours, the cylinder is removed from the filter plate and weighed to determine the amount of fluid absorbed.

The following section 6.5 has been added:

6.5 12 L Square plastic tub as available from VWR International GmbH, Darmstadt, Germany under the article reference CORAG606221.

Section 6.1.5 is replaced by the following:

6.1.5 Plastic piston, with a cylindrical weight, of which the total mass is equal to (1394±5) g. The piston diameter, d2, is such that d1−d2=(0.8±0.2) mm, and the height of the cylindrical weight is (60,0±0.5) mm.

Section 8.1 is replaced by the following:

8.1 Weigh, to the nearest 0.0005 g, a 0.400 g test portion of PA superabsorbent powder test sample and record the mass, m_{S}.

Section 8.7 is replaced by the following:

8.7.1 Place the cylinder apparatus (piston and cylinder) on the damp filter paper simultaneously adding the weight to the apparatus and cover the Petri dish and the complete apparatus (cylinder apparatus and weight) with the plastic tub to avoid the evaporation of the sodium chloride solution. Allow the test portion to absorb the saline solution for 24 h±0.5 h
8.7.2 Remove the plastic tub and lift the complete apparatus (cylinder apparatus and weight)
8.7.3 Discard the sodium chloride solution contained in the Petri dish and the filter paper
8.7.4 Repeat steps 8.5 and 8.6 wherein a new round filter paper is placed on the filter plate.
8.7.5 Replace the complete apparatus (cylinder apparatus and weight) on the new damp filter paper and cover the Petri dish and the complete apparatus (cylinder apparatus and weight) with the plastic tub to avoid the evaporation of the sodium chloride solution. Allow the test portion to absorb the saline solution for another 24 h±0.5 h.
8.7.6 Repeat steps 8.7.2 to 8.7.5 twice until the absorption contact time of 96 h is reached.

Section 9 is replaced by the following:

For each portion, calculate the absorption against pressure after 96 h (96 h-AAP) expressed as a mass fraction in g/g:

$${Q}_{( 96 h )} = \frac{{m}_{B} - {m}_{A}}{{m}_{S}}$$

### Where:

m_{S} is the mass, expressed in grams, of the dry test portion
m_{A} is the mass, expressed in grams, of dry cylinder apparatus
m_{B} is the mass, expressed in grams, of the cylinder apparatus after suction
Take the average of the 2 calculated values.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method for determining the performance of a superabsorbent polymer comprising the steps of:
a) inputting the value(s) of one or more first molecular parameter(s) of the superabsorbent polymer into a coarse-grained molecular dynamics model; and
calculating the value(s) of one or more first performance output parameter(s);
b) inputting the value(s) of one or more second molecular parameter(s) of the superabsorbent polymer into said coarse-grained molecular dynamics model; and
calculating the value(s) of one or more second performance output parameter(s); and
c) determining the variation between the value(s) of the one or more first performance output parameter(s) and the value(s) of the one or more second performance output parameter(s).

2. The method according to claim 1, wherein the performance of the superabsorbent polymer is determined for a swollen gel of the superabsorbent polymer which is contained in a liquid selected from deionized water or a saline solution.

3. The method according to claim 1, wherein the value(s) of one or more first molecular parameter(s) inputted in step a), form a first input value set of a first molecular parameter set, and the value(s) of one or more second molecular parameter(s) inputted in step b), form a second input value set of a second molecular parameter set; and wherein said first and second molecular parameter sets are the same and comprise at least one molecular parameter selected from the group consisting of: cross-linker density, polydispersity index, percentage of dangling chains, degree of neutralization, functionality of the cross-linker molecules, percentage of extractable, molecular weight of the monomers and combinations thereof.

4. The method according to claim 3, wherein said first and second input value sets for a given molecular parameter are within the ranges of: a cross-linker density from about 0.01 to 2 mol %; a polydispersity index from about 1 to about 5; a percentage of dangling chains from 0 to about 50%; a degree of neutralization from 0 to about 100 mol %, a percentage of extractable from 0 to about 50%, and a molecular weight of the monomers from about 28 to about 72 g/mol.

5. The method according to claim 4, wherein said first and second input value sets for the molecular parameter of degree of neutralization is from about 50 to about 100 mol %.

6. The method according to claim 3, wherein said first and second input value sets for the molecular parameter of functionality of the cross-linker molecules is selected from tetra-functional, hexa-functional or octafunctional cross-linker molecules.

7. The method according to claim 3, wherein the first input value set and the second input value set inputted in step a) and b) respectively comprise the values of the cross-linker density.

8. The method according to claim 1, wherein the value(s) of one or more first performance output parameters calculated in step a), form a first output value set of a first output parameter set, and the value(s) of one or more second performance output parameters calculated in step b), form a second output value set of a second output parameter set, and wherein said first and second output parameter sets comprise performance output parameters selected from the group consisting of:
swelling capacity, bulk modulus, shear modulus, and combinations thereof.

9. The method according to claim 8, wherein the swelling gel of the superabsorbent polymer has a swelling volume V and an internal pressure Pᵢₙₜ;
wherein the liquid in which the swelling gel of the superabsorbent polymer is contained exerts an external pressure Pₑₓₜ onto the superabsorbent polymer gel; and
wherein the values of the swelling capacity and the bulk modulus of the superabsorbent polymer are calculated by:
i) inputting increasing values Vᵢ for the swelling volume V;
ii) calculating the corresponding internal pressure values Pᵢₙₜ, for each value Vᵢ inputted in step i);
iii) generating a P_{int, i}=f(Vᵢ) diagram; and
iv) calculating the values of the swelling capacity and the bulk modulus from the diagram generated in step iii), the value of the swelling capacity of the superabsorbent polymer being proportional to the value of the swelling volume V_{i (eq)} for which the internal pressure Pᵢₙₜ is equal to the external pressure Pₑₓₜ and the value of the bulk modulus being equal to the slope of the P_{int, i}=f(Vᵢ) diagram generated in step iii) at Vᵢ=V_{i (eq)}.

10. The method according to claim 8, wherein the value of the shear modulus of the superabsorbent polymer is calculated by:
i) inputting increasing values xᵢ for the shear strain of the superabsorbent polymer having a swelling volume value Vᵢ=V_{i (eq)};
ii) calculating the corresponding shear stress yᵢ for each value xᵢ inputted in step i);
iii) generating a yᵢ=f(xᵢ) diagram;
iv) calculating the value of the shear modulus from the diagram generated in step iii), the shear modulus being equal to the slope of the yᵢ=f(xᵢ) diagram generated in step iii).

11. The method according to claim 1, further comprising the steps of:
d) obtaining a first superabsorbent polymer material; and measuring analytically the value(s) of said one or more first molecular parameter(s) of said first superabsorbent polymer material; measuring analytically the value(s) of said one or more first performance output parameter(s); and
e) obtaining a second superabsorbent polymer material; and measuring analytically the value(s) of said one or more second molecular parameter(s) of said second superabsorbent polymer material; measuring analytically the value(s) of said one or more second performance output parameter(s); and
f) determining the variation between the value(s) of the one or more first performance output parameter(s) measured in step d) and the value (s) of the one or more second performance output parameter(s) measured in step e); and
g) comparing the variation determined in step f) with the variation determined in step c).

12. The method according to claim 1,
wherein the superabsorbent polymer comprises 16 polyelectrolyte polymer chains of polymerized monomers connected to 8 tetra-functional cross-linker molecules and counterions;
wherein the polymerized monomers of the polyelectrolyte chains interact with one another intra and inter molecular, with the cross-linker molecules and with the counterions via a truncated and shifted Lennard-Jones or Weeks-Chandler-Anderson potential as defined in the following formula:
$${U}_{LJ} ( {r}_{ij} < {r}_{cut} ) = 4 ε [ {( \frac{σ}{{r}_{ij}} )}^{12} - {( \frac{σ}{{r}_{ij}} )}^{6} + \frac{1}{4} ] ;$$
wherein the polymerized monomers of a same polyelectrolyte polymer chain interact with one another and with the cross-linker molecules to which the chain is connected via a Finitely Extendible Nonlinear Elastic (FENE) potential as defined in the following formula:
$$U ( {r}_{ij} ) = - \frac{1}{2} {KR}_{max}^{2} ln [ 1 - {( \frac{{r}_{ij} - {r}_{0}}{{R}_{max}} )}^{2} ] ;$$
wherein the polymerized monomers of the polyelectrolyte polymer chains of the model interact with one another intra and inter molecular and with the counterions; and
wherein the counterions interact with one another via a coulomb potential as defined in the following formula:
$${U}_{C} ( {r}_{ij} ) = {l}_{B} {k}_{B} T \frac{{q}^{2}}{{r}_{ij}} .$$

13. The method according to claim 1, wherein the superabsorbent polymer is a partially neutralized polyacrylic acid and/or polyacrylate polymer.

14. The method according to claim 1, wherein the model is formulated using the software package ESPRESSO or LAMMPS.

15. A computer system having a central processing unit, a graphical user interface including a display communicatively coupled to said central processing unit, and a user interface selection device communicatively coupled to the central processing unit, wherein the computer system operates the method according to claim 1.

16. A process for obtaining superabsorbent polymer materials suitable for use in absorbent articles, the process comprising:
a) exercising the method according to claim 1 multiple times, inputting various different values for each molecular parameter until a set of targeted output parameter values are obtained; and
b) synthesizing the superabsorbent polymer material(s) that meet the set of targeted output parameter values.

17. A process for obtaining superabsorbent polymer materials suitable for use in absorbent articles, the process comprising:
a) exercising the method according to claim 11 multiple times, inputting various different values for each molecular parameter until a set of targeted output parameter values are obtained; and
b) synthesizing the superabsorbent polymer material(s) that meet the set of targeted output parameter values.
